(19) United States
(12) Patent Application Publication
(10) Pub. No.: US 2011/0227865 A1
(43) Pub. Date: Sep. 22, 2011

(54) APPARATUS AND METHOD FOR DRIVING TOUCH PANEL

(76) Inventor: Young Jin Baek, Seoul (KR)

(21) Appl. No.: 13/046,125

(22) Filed: Mar. 11, 2011

(30) Foreign Application Priority Data
Mar. 19, 2010 (KR) 10-2010-0024834

(51) Int. Cl. G06F 3/045

(52) U.S. Cl. 345/174

(57) ABSTRACT

Disclosed herein is an apparatus and method for driving a touch panel, which the touch panel is insensitive to noise while increasing sensitivity rather than that of an output voltage generated by a change in capacitance. An apparatus for driving a touch panel includes a sampling unit for receiving a voltage generated by a change in the capacitance of the touch panel as an input, comparing the inputted voltage with a previously stored value, storing the voltage in a minimum value storage unit or a maximum value storage unit based on a comparison result, and performing a weighted average operation on the stored voltage with a value stored in an average storage unit to which a weight is applied; a multiplexer for receiving averages stored in the average storage unit and sequentially outputting the averages; a maximum/minimum subtracter for receiving minimum and maximum averages inputted from the multiplexer, applying a first gain to the minimum and maximum averages so as to amplify them, and applying a second gain to a difference between the amplified minimum and maximum averages; an analog to digital converter (ADC) for receiving an output inputted from the maximum/minimum subtracter and converting the output into a digital value; and a control unit for receiving an output inputted from the ADC, recognizing a touch of the touch panel, and controlling a gain of the maximum/minimum subtracter.

### CROSS-REFERENCE TO RELATED APPLICATION

This application claims priority from and the benefit of Korean Patent Application No. 10-2010-0024834, filed on Mar. 19, 2010, which is hereby incorporated by reference for all purposes as if fully set forth herein.

### BACKGROUND

1. Field of the Invention

Disclosed herein is an apparatus and method for driving a touch panel. More particularly, disclosed herein is an apparatus and method for driving a touch panel, which can drive the touch panel through continuously weighted average driving of a voltage generated by a change in capacitance due to a touch.

2. Description of the Related Art

FIG. 1 is a block diagram showing an apparatus for driving a touch panel according to a related art.

Referring to FIG. 1, the related art apparatus includes an amplification input unit 10, a sampling unit 20, a multiplexer 30, an analog to digital converter (ADC) 40 and a controller 50.

When the touch panel is touched by a finger, the amplification input unit 10 receives a voltage generated by a change in the capacitance of a capacitor connected to the pixel touched by the finger as an input and amplifies the voltage.

The sampling unit 20 stores an output voltage of the amplification input unit 10 for each channel and then sends the output voltage of the amplification input unit 10 to the ADC 40 through the multiplexer 30.

The ADC 40 converts the output voltage inputted from the sampling unit 20 into a digital value and sends the converted digital value to the controller 50.

The controller 50 recognizes whether or not an external touch occurs in the touch panel based on the value received from the ADC 40, and detects the position of the touch.

In the related art apparatus, the sampling unit includes single output amplifiers as many as the number of channels. The sampling unit functions only to store and amplify an output voltage for each channel and then send the output voltage through the multiplexer.

In the related art apparatus, if surroundings are changed and the state of the touch panel is changed, it is difficult to ensure a stable touch sensing operation with high sensitivity. That is, it is difficult to cope with false triggering caused by a change in environment, and the like.

### SUMMARY OF THE INVENTION

Disclosed herein is an apparatus and method for driving a touch panel, in which touch recognition is controlled to be determined through a difference between maximum and minimum values obtained by performing a weighted average operation on values respectively generated when a touch occurs and when, no touch occurs, so that the touch panel insensitive to noise while increasing sensitivity rather than that of a real output voltage generated by a change in capacitance.

Further disclosed herein is an apparatus and method for driving a touch panel, which is insensitive to a change in environment and the like even when false triggering is caused by such a change.

In one embodiment, there is provided an apparatus for driving a touch panel, the apparatus including a sampling unit for receiving a voltage generated by a change in the capacitance of the touch panel as an input, comparing the inputted voltage with a previously stored value, storing the voltage in a minimum value storage unit or a maximum value storage unit based on a comparison result, and performing a weighted average operation on the stored voltage with a value stored in an average storage unit to which a weight is applied; a multiplexer for receiving averages stored in the average storage unit and sequentially outputting the averages; a maximum/minimum subtracter for receiving minimum and maximum averages inputted from the multiplexer, applying a first gain to the minimum and maximum averages so as to amplify them, and applying a second gain to a difference between the amplified minimum and maximum averages; an analog to digital converter (ADC) for receiving an output inputted from the maximum/minimum subtracter and converting the output into a digital value; and a control unit for receiving an output inputted from the ADC, recognizing a touch of the touch panel, and controlling a gain of the maximum/minimum subtracter.

The sampling unit may include at least one comparator for comparing the previously stored value with a current input value; at least one minimum value storage unit for storing the current input value when the current input value is smaller then the previously stored value as a comparison result; at least one minimum average value storage unit for performing a weighted average operation with the value stored in the minimum value storage unit; at least one maximum value storage unit for storing the current input value when the current input value is greater than the previously stored value as the comparison result; and at least one maximum average value storage unit for performing a weighted average operation with the value stored in the maximum value storage unit.

Each of the minimum value storage unit and the maximum value storage unit may be configured as a first capacitor with a first capacitance. Each of the minimum average storage unit and the maximum average storage unit may be configured as a second capacitor with a second capacitance. The first and second capacitors may be connected in parallel with each other by a switch.

The maximum/minimum subtracter may include a minimum value amplifier for receiving a minimum average inputted from the multiplexer and amplifying the minimum average with the first gain; a maximum value amplifier for receiving a maximum average inputted from the multiplexer and amplifying the maximum average with the first gain; and a subtracter for receiving output values of the minimum value amplifier and the maximum value amplifier and outputting a difference of the output values of the minimum value amplifier and the maximum value amplifier.

In one embodiment, there is provided a method for driving a touch panel, the method including receiving a voltage generated by a change in the capacitance of the touch panel as an input and comparing the voltage with a previously stored value; storing the voltage in a minimum value storage unit when the voltage is smaller than the previously stored voltage as a comparison result, and storing the voltage in a maximum value storage unit when the voltage is greater than the previously stored voltage as the comparison result; performing a weighted average operation on the value stored in the minimum or maximum value storage unit with the value stored in an average storage unit to which a weight is applied, and storing the value subjected to the weighted average operation in a minimum or maximum average storage unit; sequentially outputting values respectively stored in the minimum and maximum average storage units; and evaluating a difference between the outputted maximum and minimum average values, and outputting the difference.

In the comparing of the current input value with the previously stored value, the current input value may be stored in the minimum and maximum value storage units when there is no previously stored value.

The evaluating and outputting of the difference between the outputted maximum and minimum average values may be to apply a first gain to the outputted maximum and minimum average values and then amplify them, and to evaluate and output a difference between the amplified maximum and minimum average values.

The evaluating and outputting of the difference between the outputted maximum and minimum average values is to apply a second gain to the difference between the maximum and minimum average values and then output them.

### BRIEF DESCRIPTION OF THE DRAWINGS

The above and other aspects, features and advantages of the present invention will become apparent from the following description of preferred embodiments given in conjunction with the accompanying drawings, in which:

FIG. 1 is a block diagram showing an apparatus for driving a touch panel according to a related art;

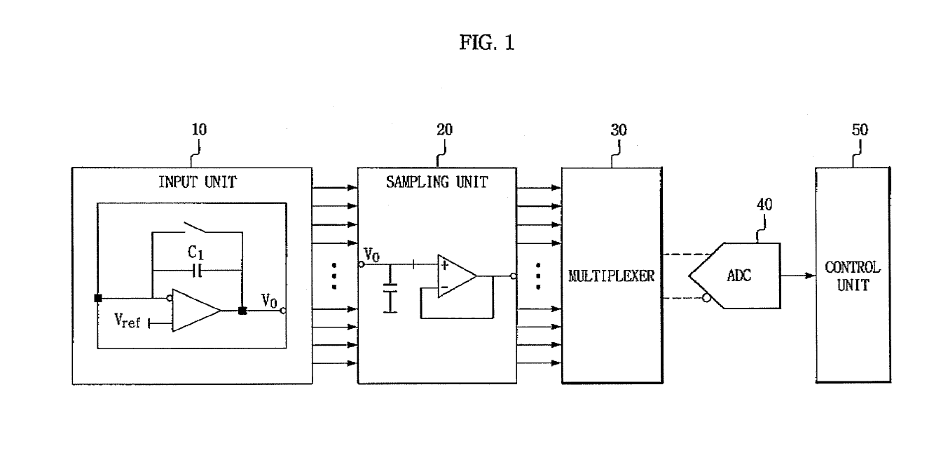

FIG. 2 is a block diagram showing the configuration of an apparatus for driving a touch panel according to an embodiment;

FIG. 3 is a circuit diagram showing an embodiment of the configuration of a sampling unit when an input unit is a single output amplifier;

FIG. 4 is a block diagram showing an embodiment of a maximum/minimum subtracter when the input unit is the single output amplifier;

FIG. 5 is a circuit diagram showing an embodiment of the configuration of the sampling unit when the input unit is a differential amplifier having two outputs;

FIG. 6 is a block diagram showing an embodiment of the configuration of the maximum/minimum subtracter when the input unit is the differential amplifier having two outputs;

FIG. 7A is a graph showing voltages of Δ(mxp, mxn) and Δ(mnp, mnn) for each frame, and FIG. 7B is a graph showing a difference between Δ(mxp, mxn) and Δ(mnp, mnn);

FIG. 8 is a table illustrating the effect for a weighted average;

FIG. 9 is a graph showing changes in average value when an output value is maintained almost constant after a time elapses as illustrated in FIG. 8;

FIG. 10 is a graph showing changes in average value when an output value is deviated from a normal operation area in the middle; and

FIG. 11 is a timing diagram showing signals for controlling the apparatus according to the embodiment.

### DETAILED DESCRIPTION OF THE INVENTION

Exemplary embodiments now will be described more fully hereinafter with reference to the accompanying drawings, in which exemplary embodiments are shown. This disclosure may, however, be embodied in many different forms and should not be construed as limited to the exemplary embodiments set forth therein. Rather, these exemplary embodiments are provided so that this disclosure will be thorough and complete, and will fully convey the scope of this disclosure to those skilled in the art. In the description, details of well-known features and techniques may be omitted to avoid unnecessarily obscuring the presented embodiments.

The terminology used herein is for the purpose of describing particular embodiments only and is not intended to be limiting of this disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

In the drawings, like reference numerals in the drawings denote like elements. The shape, size and regions, and the like, of the drawing may be exaggerated for clarity.

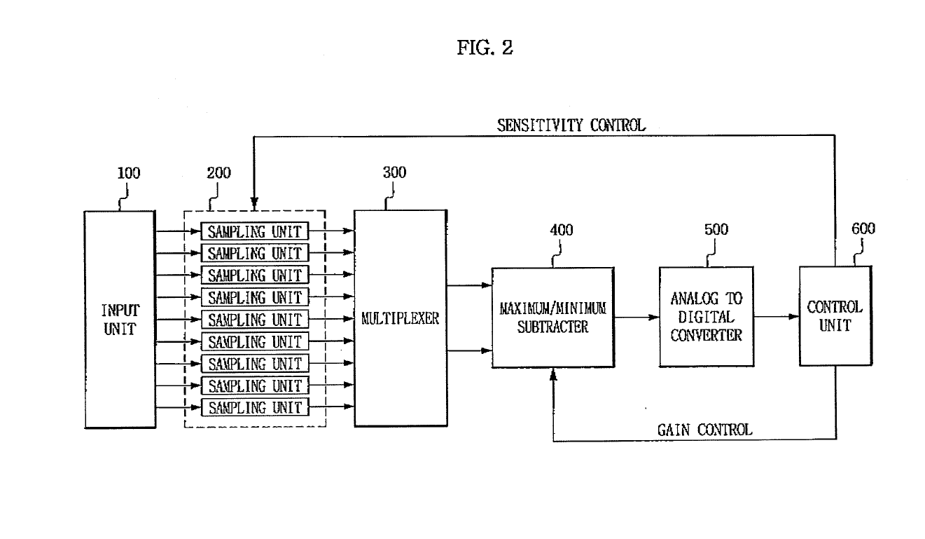

FIG. 2 is a block diagram showing the configuration of an apparatus for driving a touch panel according to an embodiment.

Referring to FIG. 2, the apparatus includes an input unit 100, sampling units 200, a multiplexer 300, a maximum/minimum subtracter 400, an analog to digital converter (ADC) 500 and a controller 600.

If the touch panel is touched by a human body such as a finger, a change in the capacitance of the capacitor in a pixel corresponding to a surface of the touch panel 100 touched by the human body occurs. The input unit 100 receives a voltage generated by such a change in capacitance as an input, and amplifies the received voltage so as to control the touch panel.

At this time, the input unit 100 may include a single output amplifier or a differential amplifier that outputs a voltage as positive and negative values.

The sampling unit 200 receives a value inputted from the input unit 100 and compares the inputted value with a previously stored value. According to the comparison result, the value is stored in a minimum value storage unit or maximum value storage unit and then stored by performing a weighted average operation on the value with a value stored in an average value storage unit to which a weighted value is applied. When the value is a value initially outputted from the input unit 100, an initial value is set by storing the value in the minimum value storage unit, the maximum value storage unit and the average value storage unit. A value subsequently outputted from the input unit 100 is compared with the previously stored value. According to the comparison result, if the value is smaller than the previously stored value, it is stored in the minimum value storage unit. If the value is greater than the previously stored value, it is stored in the maximum value storage unit.

The sampling units 200 repeats the aforementioned procedure while scanning a Tx channel through which a pulse of the touch panel. The sampling unit 200 includes sampling units as many as the number of Rx channels of the touch panel. That is, the procedure is repeated in the sampling units that exist as many as the number of Rx channels while scanning pixels of a TX channel, so that the voltage subjected to the weighted average operation is stored. In FIG. 2, an embodiment in which the number of Rx channels is 9 is described, and the number of sampling units may be varied depending on the number of Rx channels.

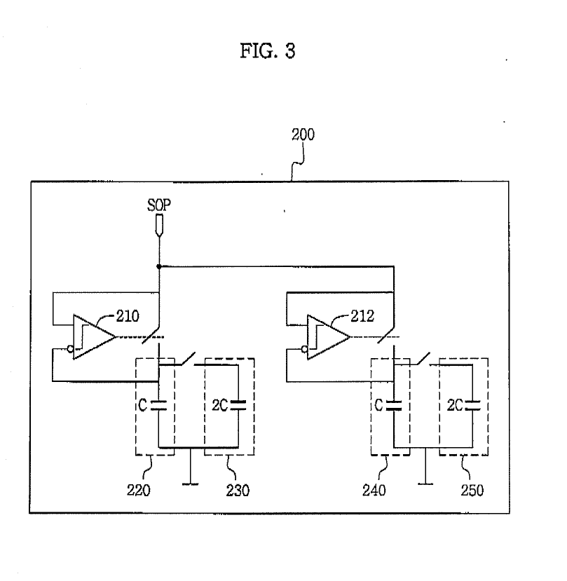

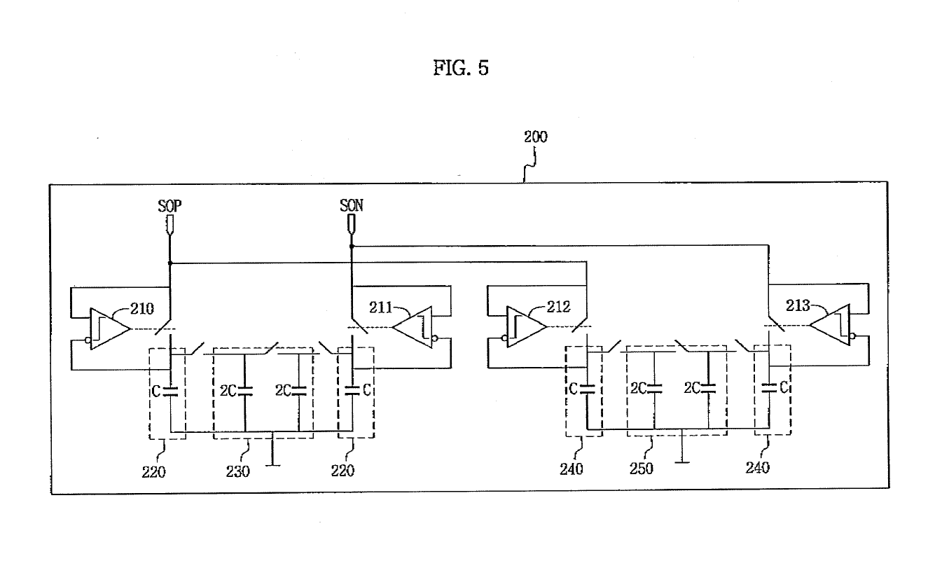

An embodiment of the structure of the sampling unit 200 will be described in detail with reference to FIGS. 3 and 5.

The output voltage of the sampling units 200 is outputted to the maximum/minimum subtracter 400 through the multiplexer 300. The maximum/minimum subtracter 400 amplifies the respective output voltages of the maximum and minimum values of the sampling unit 200 as first gains, and then applies a second gain to the difference between the amplified maximum and minimum averages.

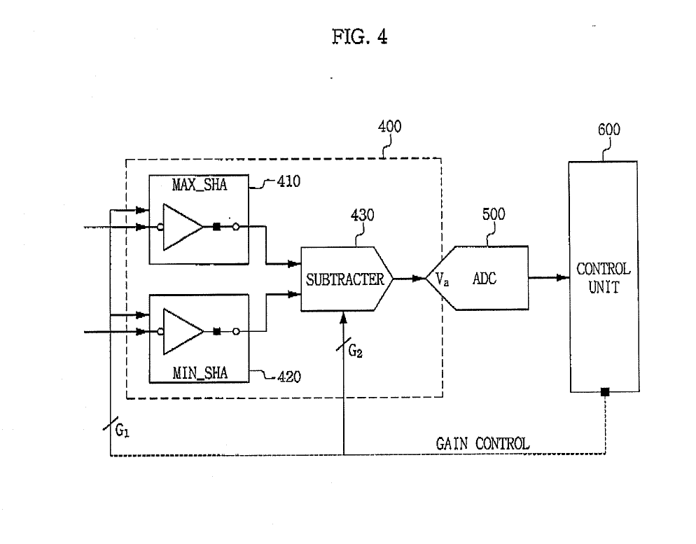

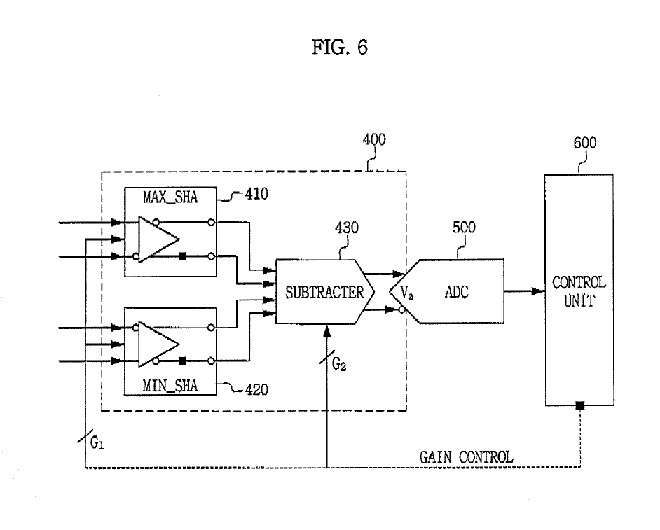

An embodiment of the structure of the maximum/minimum subtracter 400 will be described in detail with reference to FIGS. 4 and 6.

The ADC 500 receives an output of the differential amplifier as an input and then converts the output into a digital value so as to send the digital value to the controller 600.

The controller 600 receives a voltage as an input so as to detect whether or not an external touch occurs and to detect the position at which the external touch occurs. The controller 600 also performs a gain control by providing the first and second gains. In addition, the controller 600 may perform a sensitivity control of the sampling unit 200. That is, if the weight of a weighted average is varied by controlling the capacitance of the capacitor subjected to a weighted average operation, the sensitivity is varied depending on the settling time of the average value based on a change in the weight of the weighted average.

Hereinafter, the embodiments of the sampling unit 200 and the maximum/minimum subtracter 400 will be described in detail.

FIG. 3 is a circuit diagram showing an embodiment of the configuration of a sampling unit when an input unit is a single output amplifier.

Referring to FIG. 3, the sampling unit 200 may include at least one comparator, a minimum value storage unit, a minimum average storage unit, a maximum value storage unit and a maximum average storage unit.

The comparators 210 and 212 compares SOP that is an output voltage of the input unit 100 with a value previously stored therein and determines whether the SOP is stored the minimum value storage unit 220 or the maximum value storage unit 240.

In the embodiment of FIG. 3, the comparators are separately provided with the comparator 210 for determining a minimum value and the comparator 212 for determining a maximum value. However, one comparator may be used depending on embodiments.

As a comparison result of the comparator, when a current input value is smaller than the previously stored value, it is stored in the minimum value storage unit 220. The minimum value storage unit 220 may be configured as a first capacitor with a first capacitance. The minimum average value storage unit 230 may be configured as a second capacitor with a second capacitance obtained by applying a weight to the first capacitance. In the embodiment of FIG. 3, the first capacitor is designated by C, and the second capacitor having a weight of 2 applied thereto is designated by 2C. The weight may be provided as a number more than 1. The first and second capacitors are connected in parallel with each other, and may be connected by a switch. That is, the output value of the comparator is stored in the minimum value storage unit 220, and a weighted average operation on the output value is performed with the capacitance of the minimum average storage unit 230 when the switch is closed.

As a comparison result of the comparator, when the current input value is greater than the previously stored value, it is stored in the maximum value storage unit 240. The maximum value storage unit 240 may be configured as a first capacitor with a first capacitance. The maximum average storage unit 250 may be configured as a second capacitor with a second capacitance obtained by applying a weight to the first capacitance. In the embodiment of FIG. 3, the first capacitor is designated by C, and the second capacitor having a weight of 2 applied thereto is designated by 2C. The weight may be a positive integer. The first and second capacitors are connected in parallel with each other, and may be connected by a switch. That is, the output value of the comparator is stored in the maximum value storage unit 240, and a weighted average operation on the output value is performed with the capacitance of the maximum average storage unit 250 when the switch is closed.

The first and second capacitors may be controlled to be connected by the switch therebetween when the weighted average operation is performed. If a voltage is stored in the minimum value storage unit 220 or the maximum value storage unit 240, the switch may be controlled to be closed in real time.

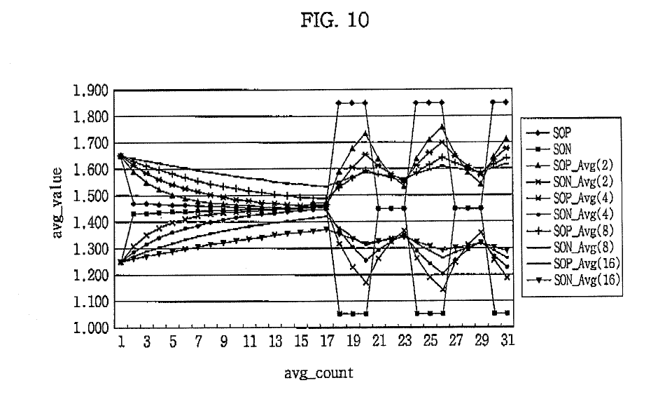

Differences in effect depending on sizes of the weight are illustrated in FIG. 10.

FIG. 4 is a block diagram showing an embodiment of the maximum/minimum subtracter 400 when the input unit is the single output amplifier.

Referring to FIG. 4, the maximum/minimum subtracter 400 may include a maximum value amplifier 410, a minimum value amplifier 420 and a subtracter 430.

The voltage stored in the minimum average storage unit 230 and the maximum average storage unit 250 in the sampling unit 200 is inputted to the maximum/minimum subtracter 400 through the multiplexer 300. The maximum average value is amplified by the maximum value amplifier 410, and the minimum average value is amplified by the minimum value amplifier 420. At this time, the controller 500 provides a first gain to each of the maximum value amplifier 410 and the minimum value amplifier 420 so that a signal is amplified by the first gain.

Subsequently, output values of the maximum value amplifier 410 and the minimum value amplifier 420 are inputted to the subtracter 430 so as to evaluate a difference between the output values. At this time, the controller 500 provides a second gain to the subtracter 430 so that the second gain is provided to the difference between the output values of the maximum value amplifier 410 and the minimum value amplifier 420.

The voltage Vₐ provided with the first and second gains is represented by Equation 1 as follows.

Vₐ=G₁εG₂[Avg(Max)−Avg(Min)] (1)

Here, Vₐ denotes a difference between voltages respectively generated when a touch occurs and when no touch occurs. G₁ is a first gain, and G₂ is a second gain. Avg(Max) denotes a result obtained by performing a weighted average operation on the voltage stored as a maximum value with a value provided with a weight. Avg(Min) denotes a result obtained by performing a weighted average operation on the voltage stored as a minimum value with a value provided with a weight.

The apparatus disclosed herein includes the sampling unit, the multiplexer and the maximum/minimum subtracter so that an amplified voltage is sent to the controller. In the related art apparatus, amplifiers are necessarily provided as many as the number of sampling units. However, in the apparatus disclosed herein, only the maximum value amplifier and the minimum value amplifier are provided to the maximum/minimum subtracter regardless of the number of sampling units, thereby saving manufacturing cost. Here, the apparatus disclosed herein is not limited to the two amplifiers included in the maximum/minimum subtracter. That is, the apparatus disclosed herein includes the maximum value amplifier for amplifying the maximum average and the minimum value amplifier for amplifying the minimum average in the sampling unit, and a plurality of amplifiers having the same function are also within the scope disclosed herein.

The Vₐ is inputted to the ADC 500.

FIG. 5 is a circuit diagram showing an embodiment of the configuration of the sampling unit when the input unit is a differential amplifier having two outputs. That is, the embodiment of the configuration of the sampling unit when the number of output values of the input unit is two is shown in FIG. 5.

Referring to FIG. 5, the sampling unit 200 may include at leas one comparator, at least one minimum value storage unit, at least one minimum average storage unit, at least one maximum value storage unit and at least one maximum average storage unit.

The comparators may be provided with comparators 210, 211, 212 and 213 for respectively determining minimum and maximum values for positive and negative output voltages SOP and SON.

According to the result determined by each of the comparators, a plurality of minimum value storage units 220 having minimum values for positive and negative input voltages respectively stored therein are provided the sampling unit 200, and a plurality of maximum value storage unit 240 having maximum values for the positive and negative input voltages stored therein are provided to the sampling unit 200. A plurality of minimum average storage units 230 for the positive and negative input voltages are provided to the sampling unit 200, and a plurality of maximum average storage units 230 for the positive and negative input voltages are provided to the sampling unit 200.

The detailed operations of the components in the sampling unit of FIG. 5 will be identical to those of the components in the sampling unit of FIG. 3.

FIG. 6 is a block diagram showing an embodiment of the configuration of the maximum/minimum subtracter when the input unit is the differential amplifier having two outputs.

Referring to FIG. 6, the maximum/minimum subtracter 400 may include a maximum value amplifier 410, a minimum value amplifier 420 and a subtracter 430. The maximum value amplifier 410 has two outputs, and the minimum value amplifier 420 also has two outputs.

The two outputs of the maximum amplifier 410 and the two outputs of the minimum amplifier 420 are all inputted to the subtracter 430. The subtracter 430 outputs an output value obtained by providing a first gain to the difference between the maximum values for the positive and negative inputs and an output value obtained by providing a second gain to the difference between the minimum values for the positive and negative inputs.

The detailed operations of the components in the maximum/minimum subtracter of FIG. 6 will be identical to those of the components in the maximum/minimum subtracter of FIG. 4.

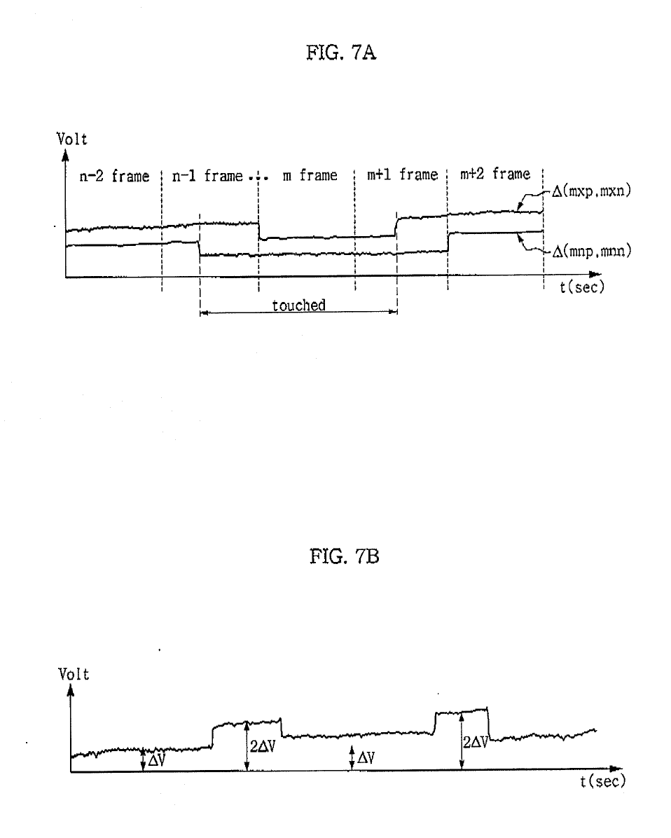

FIG. 7A is a graph showing voltages of Δ(mxp, mxn) and Δ(mnp, mnn) for each frame, and FIG. 7B is a graph showing a difference between Δ(mxp, mxn) and Δ(mnp, mnn). At this time, mxp, mxn, mnp and mnn denote a positive maximum value, a negative maximum value, a positive minimum value and a negative minimum value, respectively. Δ(mxp, mxn) denotes a difference between the positive maximum value and the negative maximum value, and Δ(mnp, mnn) denotes a difference between the positive minimum value and the negative minimum value.

Referring to FIG. 7B, a section in which a change in a touched state or a change from a touched state to an untouched state is generated when the difference between the Δ(mxp, mxn) and the Δ(mnp, mnn) is changed can be extracted by the difference between the Δ(mxp, mxn) and the Δ(mnp, mnn). That is, in FIG. 7B, the change in the touched state when the can be extracted when the difference between the Δ(mnp, mxn) and the Δ(mnp, mnn) is changed from ΔV to 2ΔV, and the change from the touched state to the untouched state can be extracted when the difference between the Δ(mnp, mxn) and the Δ(mnp, mnn) is again changed from ΔV to 2ΔV.

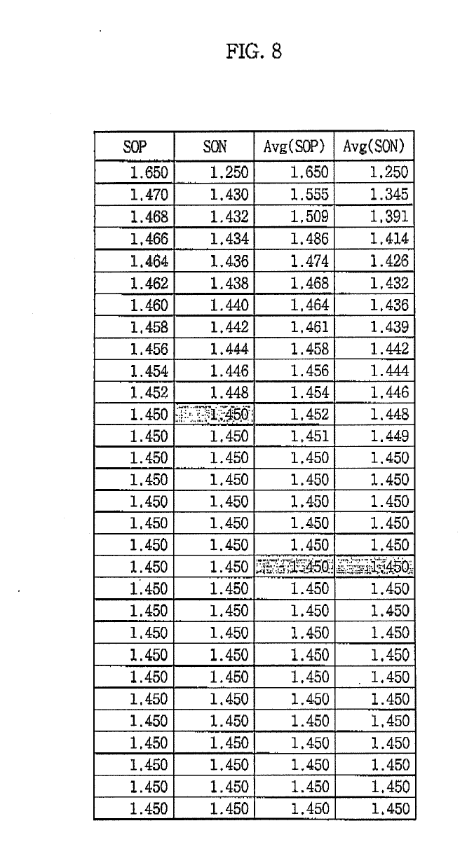

FIG. 8 is a table illustrating the effect for a weighted average. Changes in average when a weighted average operation is performed with respect to 31 sampling values are shown in FIG. 8.

Referring to FIG. 8, Avg(SOP) and Avg(SON) slowly follow SOP and SON rather than changes in the voltages of SOP and SON. Thus, since Avg(SOP) and Avg(SON) do not follow the abrupt occurrence of an error, they are insensitive to noise.

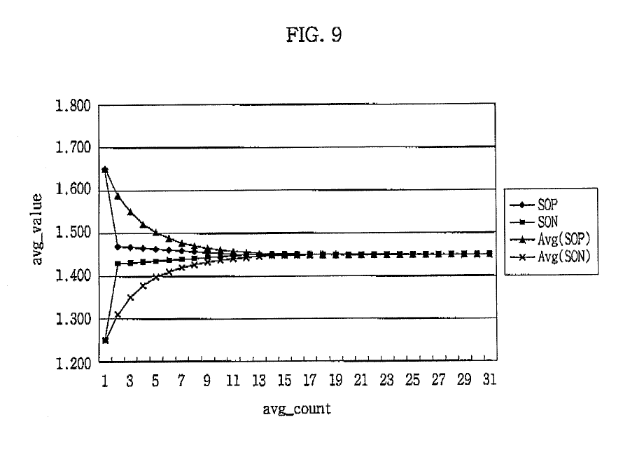

FIG. 9 is a graph showing changes in average value when an output value is maintained almost constant after a time elapses as illustrated in FIG. 8. FIG. 10 is a graph showing changes in average value when an output value is deviated from a normal operation area in the middle. Moreover, FIG. 10 shows the effect obtained by varying a weight in the weighted average operation.

Referring to FIG. 9, when an output value is maintained constant in a certain time even though an abrupt change of the output value, the change in weight is not sensed as false triggering but sensed as the change of a real signal. The weighted average follows the change of the real signal.

Referring to FIG. 10, in the weighted average operation, the weighted average slowly follows values of the real signals of SOP and SON when the weight is increased. When the weight is decreased, the weighted average more slowly follows the values of the real signals of SOP and SON. By doing so, the sensitivity for a signal can be controlled. That is, if the weight of a weighted average is varied by controlling the capacitance of the capacitor subjected to a weighted average operation, the sensitivity is varied depending on the settling time of the average value based on a change in the weight of the weighted average. Accordingly, the sensitivity control can be performed.

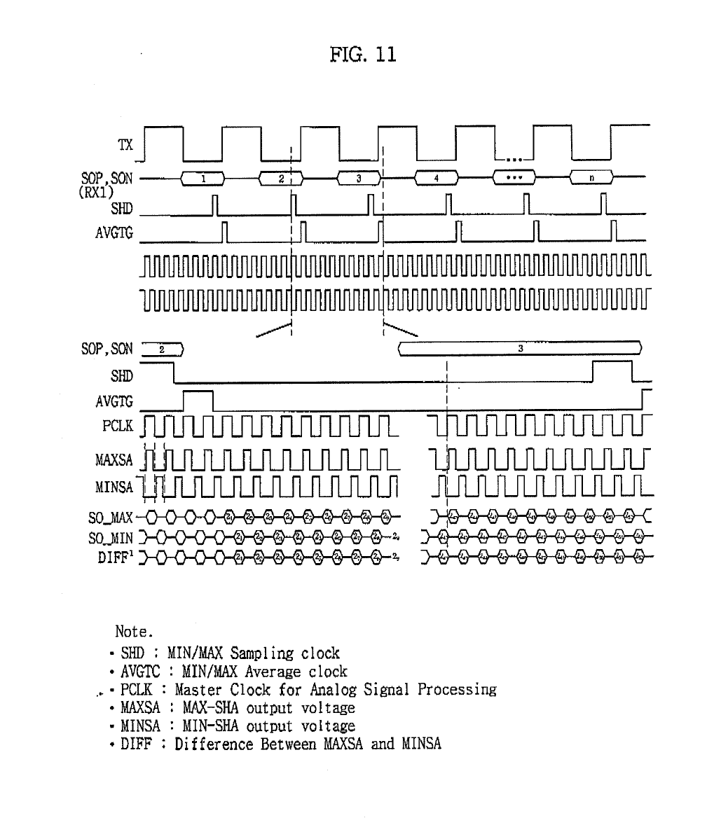

FIG. 11 is a timing diagram showing signals for controlling the apparatus according to the embodiment.

As described above, the apparatus for driving the touch panel according to the embodiment has advantages as follows.

When a touch is recognized using a voltage generated by a change in the capacitance of the touch panel, the touch recognition is controlled to be determined through a difference between maximum and minimum values obtained by performing a weighted average operation on values respectively generated when a touch occurs and when no touch occurs, so that the touch panel is insensitive to noise while increasing the sensitivity rather than that of a real output voltage generated by a change in capacitance.

Accordingly, an output voltage is sampled as an average of maximum and minimum values and determined with a difference between the maximum and minimum values by the maximum/minimum subtracter, so that errors in touch recognition due to false triggering can be reduced.

While the present invention has been described in connection with certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. An apparatus for driving a touch panel, the apparatus comprising:
a sampling unit for receiving a voltage generated by a change in the capacitance of the touch panel as an input, comparing the inputted voltage with a previously stored value, storing the voltage in a minimum value storage unit or a maximum value storage unit based on a comparison result, and performing a weighted average operation on the stored voltage with a value stored in an average storage unit to which a weight is applied;
a multiplexer for receiving averages stored in the average storage unit and sequentially outputting the averages;
a maximum/minimum subtracter for receiving minimum and maximum averages inputted from the multiplexer, applying a first gain to the minimum and maximum averages so as to amplify them, and applying a second gain to a difference between the amplified minimum and maximum averages;
an analog to digital converter (ADC) for receiving an output inputted from the maximum/minimum subtracter and converting the output into a digital value; and
a control unit for receiving an output inputted from the ADC, recognizing a touch of the touch panel, and controlling a gain of the maximum/minimum subtracter.

2. The apparatus according to claim 1, wherein the sampling unit comprises:
at least one comparator for comparing the previously stored value with a current input value;
at least one minimum value storage unit for storing the current input value when the current input value is smaller then the previously stored value as a comparison result;
at least one minimum average value storage unit for performing a weighted average operation with the value stored in the minimum value storage unit;
at least one maximum value storage unit for storing the current input value when the current input value is greater than the previously stored value as the comparison result; and
at least one maximum average value storage unit for performing a weighted average operation with the value stored in the maximum value storage unit.

3. The apparatus according to claim 2, wherein:
each of the minimum value storage unit and the maximum value storage unit is configured as a first capacitor with a first capacitance;
each of the minimum average value storage unit and the maximum average value storage unit is configured as a second capacitor with a second capacitance; and
the first and second capacitors are connected in parallel with each other by a switch.

4. The apparatus according to claim 1, wherein the maximum/minimum subtracter comprises:
a minimum value amplifier for receiving a minimum average inputted from the multiplexer and amplifying the minimum average with the first gain;
a maximum value amplifier for receiving a maximum average inputted from the multiplexer and amplifying the maximum average with the first gain; and
a subtracter for receiving output values of the minimum value amplifier and the maximum value amplifier and outputting a difference of the output values of the minimum value amplifier and the maximum value amplifier.

5. A method for driving a touch panel, the method comprising:
receiving a voltage generated by a change in the capacitance of the touch panel as an input and comparing the voltage with a previously stored value;
storing the voltage in a minimum value storage unit when the voltage is smaller than the previously stored voltage as a comparison result, and storing the voltage in a maximum value storage unit when the voltage is greater than the previously stored voltage as the comparison result;
performing a weighted average operation on the value stored in the minimum or maximum value storage unit with the value stored in an average storage unit to which a weight is applied, and storing the value subjected to the weighted average operation in a minimum or maximum average storage unit;
sequentially outputting values respectively stored in the minimum and maximum average storage units; and
evaluating a difference between the outputted maximum and minimum average values, and outputting the difference.

6. The method according to claim 5, wherein, in the comparing of the current input value with the previously stored value, the current input value is stored in the minimum and maximum value storage units when there is no previously stored value.

7. The method according to claim 5, wherein, the evaluating and outputting of the difference between the outputted maximum and minimum average values is to apply a first gain to the outputted maximum and minimum average values and then amplify them, and to evaluate and output a difference between the amplified maximum and minimum average values.

8. The method according to claim 7, wherein, the evaluating and outputting of the difference between the outputted maximum and minimum average values is to apply a second gain to the difference between the maximum and minimum average values and then output them.
